(19) United States
(12) Patent Application Publication
(10) Pub. No.: US 2012/0262496 A1
(43) Pub. Date: Oct. 18, 2012

(54) Mapping Input Component Colors Directly to Waveforms

(76) Inventor: Jerzy Wieslaw Swic, Vancouver (CA)

(21) Appl. No.: 13/088,481

(22) Filed: Apr. 18, 2011

(51) Int. Cl. G09G 5/10

(52) U.S. Cl. 345/690

(57) ABSTRACT

A method, image processing device, and an image display system for driving a bi-stable color display are disclosed. The image processing device may include first, second, third, and fourth units. The method may include receiving, and the first unit may receive, data describing a color display element of the display. The data may include descriptions of two or more component colors. The method may include determining, and the second unit may determine, a correspondence between one of the component colors and a particular subpixel of the color display element. In addition, the method may include mapping the component color to a waveform and driving the subpixel with the mapped waveform. The third unit may map the component colors to waveforms and the fourth unit may drive the subpixels with the mapped waveforms. The mappings may account for a property of the particular subpixel corresponding with the component color.

### FIELD

This application relates generally to apparatus and methods for driving bi-stable, color electro-optic display devices.

### BACKGROUND

An electro-optic material may refer to a material having at least first and second display states. The display state of an electro-optic material may be changed by applying an electric field to the material. Display states differ from one another in at least one optical property. The optical property may be a color perceptible to the human eye, or another optical property, such as optical transmission, reflectance, or luminescence. An optical property may relate to electromagnetic radiation within or outside of the portion of the spectrum perceptible to human vision.

A bistable electro-optic display may refer to a display that has display elements (also referred to as pixels, sub-pixels, or “display pixels”) that include an electro-optic material. In the art, the term “bistable” may refer to display elements having two display states or to display elements having more than two display states. The term bistable thus may be used to refer to display elements that, in fact, have multiple stable states. Generally speaking, the display state of a bistable display element may be considered stable if it will persist for at least several times the duration of the electric field that was applied to place the display element in the particular display state, for example, at least four times the field duration.

Several types of electro-optic displays are known. One type of electro-optic display is a rotating bichromal member type. A rotating bichromal member display may use a large number of small bodies that have two or more sections, each with different optical characteristics, and an internal dipole. The bodies may be suspended within liquid-filled vacuoles within a matrix. Another type of electro-optic display uses an electrochromic medium, for example, a nanochromic film that includes an electrode formed at least in part from a semi-conducting metal oxide, and a plurality of dye molecules capable of reversible color change attached to the electrode. Yet another type of electro-optic display is an electro-wetting display.

One type of electro-optic display is the particle-based electrophoretic display in which two or more particles may be suspended in a medium. The particles may be pigmented, with some particles light-colored, and others dark-colored. The light color may be white and the dark color may be black, however, this is not essential. Any suitable colors may be used. The particles may be either positively or negatively charged, with the light- and dark-colored particles having opposite charge polarities. When the charged, pigmented particles are placed in an electric field, the particles will move in the medium in response to the field, a phenomena known as electrophoresis. The medium may be a liquid or a gas. Groups of particles suspended in the medium may be enclosed in capsules. The capsules may be held within a polymeric binder to form a coherent layer that may be positioned between two electrodes. Alternatively, particles suspended within a medium may be introduced into a continuous phase of a polymeric material, which may be referred to as a polymer-dispersed electrophoretic display. In another alternative, groups of particles suspended in a medium may be enclosed in cavities formed in a carrier medium, typically a polymeric film, which may be referred to as a microcell electrophoretic display.

As mentioned, one optical property that may be associated with a display state of an electro-optic display element may be reflectance or transmission. As an example of the former property, the display states of a particle-based electro-optic display element may include varying degrees of reflectance. As an example of the latter property, the display state of a particle-based electro-optic display element may be made to operate in a “shutter mode” in which one display state is substantially opaque and another display state is light-transmissive.

It is desirable to render images as accurately as possible. It is also desirable to minimize latency and power consumption when rendering an image. The appearance of an electro-optic display may depend mainly on its reflectivity. In some lighting conditions, an electro-optic display element may reflect less light than may be desirable, which may reduce color fidelity. Taking steps to improve color fidelity may increase the time or power necessary to change a display state. Accordingly, there is a need for improved apparatus and methods for driving bi-stable, color electro-optic display devices.

### SUMMARY

A method, image processing device, and an image display system for driving a bi-stable color display are disclosed. The method may include receiving data describing a color display element of the display. The data may include descriptions of two or more component colors. The method may also include determining a correspondence between one of the component colors and a particular subpixel of the color display element. In addition, the method may include mapping the component color to a waveform and driving the subpixel with the mapped waveform. The mapping may account for a property of the particular subpixel.

In some embodiments, the particular subpixel may include a color filter and the property may include a property of the color filter. The color filter may include one of a red, green, or blue color filter. Alternatively, the color filter may include one of a red, green, blue, or white color filter. The property may include a relationship between the optical states of the particular subpixel and component color values.

In some embodiments, the method may further include generating an optimized data value by modifying an initialization data value to compensate for a display element property. In addition, a waveform may be selected using the optimized data value, the selected waveform may be mapped to an input data value, and the mappings recorded in a memory. The mapping of the component color to a waveform referred to above may include fetching the mapping from the memory.

An image processing device for driving a bi-stable color display may include first, second, third, and fourth units. The first unit may receive data describing color pixels of the display. The data may include, for each color pixel, descriptions of two or more component colors. The second unit may determine correspondences between the component colors and particular subpixels of particular color pixels. The third unit may map the component colors to waveforms. The mappings may account for a property of the particular subpixel corresponding with the component color. The fourth unit may drive the subpixels with the mapped waveforms.

In some embodiments, the particular subpixel may include a color filter and the property includes a property of the color filter. The color filter may include one of a red, green, or blue color filter. Alternatively, the color filter may include one of a red, green, blue, or white color filter. The property may include a relationship between the optical states of the particular subpixel and component color values.

The image display system may include: a bi-stable color display, and first, second, third, and fourth units. The first unit may receive data describing color pixels of the display. The data may include, for each color pixel, descriptions of two or more component colors. The second unit may determine correspondences between the component colors and particular subpixels of particular color pixels. The third unit may map component colors to waveforms. The mappings may account for a property of the particular subpixel corresponding with the component color. The fourth unit may drive the subpixels with the mapped waveforms.

In some embodiments, the particular subpixel may include a color filter and the property includes a property of the color filter. The color filter may include one of a red, green, or blue color filter. Alternatively, the color filter may include one of a red, green, blue, or white color filter. The property may include a relationship between the optical states of the particular subpixel and component color values.

### DRAWINGS

FIG. 1 depicts a simplified cross-sectional representation of a portion of an exemplary bi-stable, monochrome electro-optic display device.

FIG. 2 illustrates exemplary waveforms for changing the display state of an exemplary bi-stable, electro-optic display element.

FIG. 3 depicts a simplified cross-sectional representation of a portion of an exemplary bi-stable, color electro-optic display device.

FIG. 4 illustrates methods for driving a bi-stable, electro-optic color display according to one embodiment.

FIG. 5 shows an exemplary display system for driving a bistable, color electro-optic display device according to one embodiment.

FIG. 6 shows an exemplary display system for driving a bistable, color electro-optic display device according to one alternative embodiment.

### DETAILED DESCRIPTION

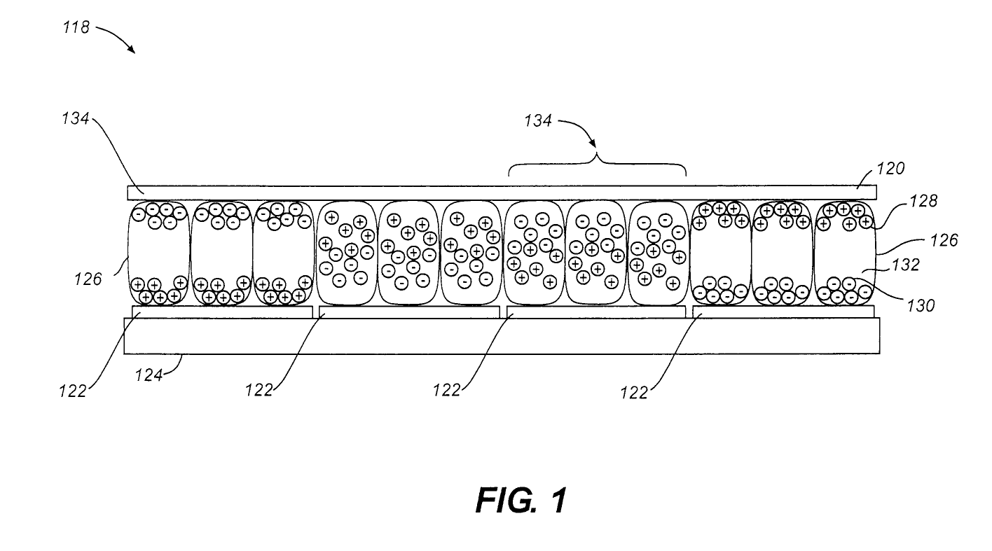

FIG. 1 depicts a simplified cross-sectional representation of a portion of an exemplary electro-optic display 118, according to one embodiment. The display 118 may include electrophoretic media sandwiched between a transparent common electrode 120 and a plurality of display element electrodes 122. One side of the display element may be designated as a viewing side (e.g., the transparent common electrode 120 side), the opposite side being a non-viewable side. The display element electrodes 122 may reside on a substrate 124. The electrophoretic media may include one or more microcapsules 126. Each microcapsule 126 may include positively charged white particles 128 and negatively charged black particles 130 suspended in a fluid 132. Alternatively, white particles may be negatively charged and the black particles positively charged. In addition, it is not critical that the particles be only white and black; other colors may be used. In one embodiment, each display element 134 may correspond with one display element electrode 122, however, this is not required. In addition, each display element 134 may correspond with one or more microcapsules 126. A display element 134 will appear lighter in response to an electric field that causes light-colored particles 128 to move toward and dark-colored particles 130 away from the viewing side. An electro-optic display element 134 exposed to an electric field of opposite polarity will appear darker. Accordingly, the electro-optic display element 134 may be placed in a particular display state by introducing an electric field across the element.

The pair of electrodes separating the group of one or more capsules of the electro-optic display element may be controlled in any suitable manner. In one embodiment, an electro-optic display element 134 may be formed using an active-matrix of electrodes. In an alternative embodiment, an electro-optic display element 134 may be formed using a passive-matrix of electrodes. In one embodiment, an electro-optic display may include a matrix of display elements 134, each display element including one or more capsules containing multiple particles suspended in a medium, the group of capsules being disposed between a common electrode and a display element electrode. Establishing a voltage difference between the common and display element electrodes creates an electric field across the display element 134 causing an electromotive force on the particles. The electromotive force in turn alters the positional distribution of the particles within the medium, which in turn may change the display state of the electro-optic display element 134.

The distance that an electric field will displace the particles in a capsule is a function of time, as well as the magnitude and polarity of the voltage. In addition, particle displacement is a function of the initial position of the particles. Particle displacement may also depend on other factors, such as the viscosity of the medium and ambient temperature. Mathematically, an electric field may be specified as the integral of the voltage applied to the electrodes with respect to time. Accordingly, applying a large voltage for a short time may produce the same displacement as applying a smaller voltage for a longer time, provided the time integrals of the voltages are equal. Similarly, a single voltage for a long time may produce the same displacement as two or more voltages pulses for shorter times, again provided the time integrals of the several voltages are equal. As this example indicates, it is not essential that a voltage be applied continuously over a particular time period. A series of voltages spaced apart in time may be placed across a display element. In addition, it is not essential that every voltage in a series of voltages have the same magnitude or even the same polarity. In fact, it may be desirable to set up a series of voltages (that may or may not be spaced apart in time) of varying magnitude and polarity across a display element. Voltages that vary in duration, magnitude, and polarity may be desirable, for example, to provide an initial “shaking” of the particles, to improve DC balance, to conserve energy, or to address other needs. One of ordinary skill in the art will appreciate that a particular time integral of voltage may be generated by a multitude of combinations of voltages and time.

In this description, the terms “waveform” or “drive waveform” refer to a particular combination of voltages and associated time periods that may be employed to cause a display element to transition to a new display state. In this description, a single, continuous voltage for some period of time may be referred to as a “voltage pulse” or “pulse.” Using these definitions, a drive waveform may include one or more voltage pulses. In one embodiment, a waveform includes two or more voltage pulses. It will be appreciated that multiple different waveforms may be used to cause a display element to transition to one particular display state.

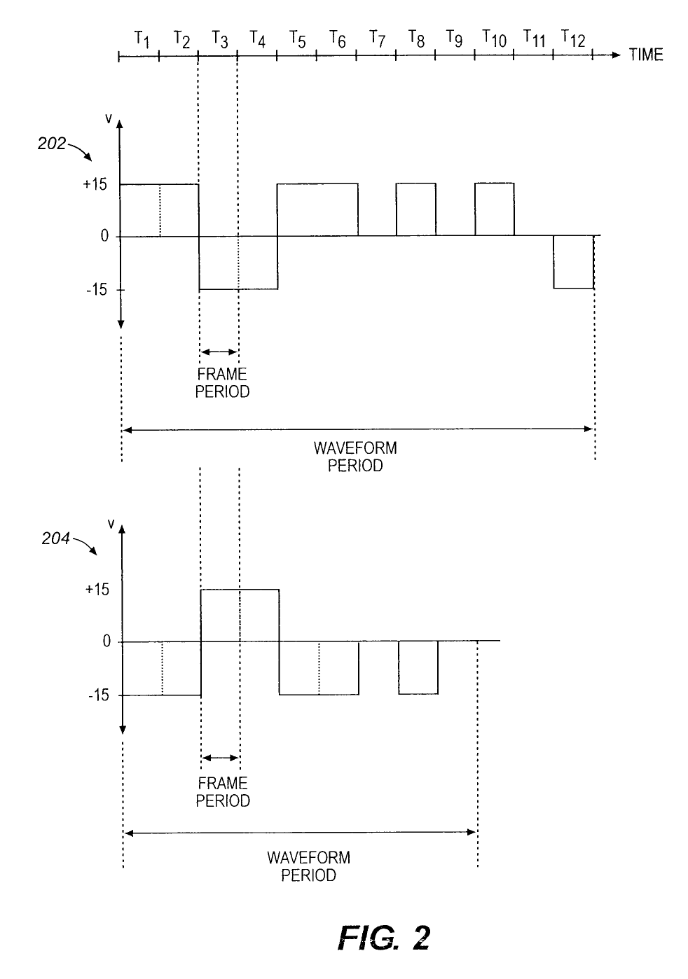

FIG. 2 illustrates exemplary waveforms 202 and 204. The time period in which a single pulse is asserted may be referred to as the frame period. The time associated with the entire sequence of pulses, along with any resting periods, may be referred to the waveform period. The waveforms 202 and 204 have different waveform periods.

As mentioned, particle displacement depends on the initial position of the particles in the medium. Accordingly, providing a single waveform for each possible display state may not be sufficient. Instead, for each possible final display state, a unique waveform may be needed for every possible initial display state. In other words, a different waveform may be needed for every possible transition from an initial display state to a final display state. In one embodiment, a drive waveform may be provided for each possible display state transition. Under particular conditions, the set of drive waveforms for all possible display state transitions may be referred to as a “drive scheme.” For a particular electro-optic display device, different drive schemes, i.e., sets of drive waveforms, may be provided to compensate for different temperature conditions or other factors.

Applying a waveform to a display element 134 generally causes the pigmented particles to be redistributed. Various display states may correspond with how pigmented particles are distributed within the medium, however, it is recognized that it may be possible that one particular display state may correspond with two or more distributions of particles. The display state of an electro-optic display element 134 may correspond with how much light it reflects, the pixel appearing black, white, or an intermediate gray tone depending on the amount of light that is reflected. Accordingly, a particular gray level may be produced by applying a waveform to a display element 134.

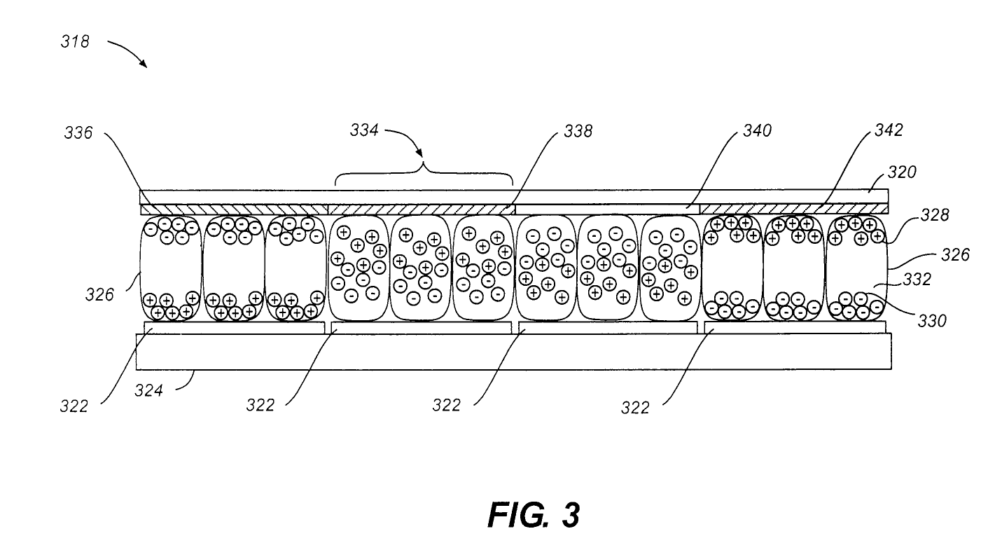

Referring to FIG. 3, a color electro-optic display element 318 may include a color filter placed on the viewing side of the display element. FIG. 3 depicts a simplified cross-sectional representation of a portion of an exemplary electro-optic display 318, according to one embodiment. The display 318 may include electrophoretic media sandwiched between a transparent common electrode 320 and a plurality of display element electrodes 322, the display element electrodes 322 residing on a substrate 324. The electrophoretic media may be the same media described above with respect to electro-optic display 118. The electrophoretic media may include microcapsules 326, the microcapsules having light-colored particles 328 and dark-colored particles 330 suspended in a fluid 332. In addition, each display element 334 may include a filter 336, 338, 340, or 342. The filters may be disposed between the transparent common electrode 320 and the electrophoretic media. A filter may be disposed such that light incident on the particular display element associated with the filter passes through the filter. A filter may be placed adjacent to the microcapsules 326 associated with the particular display element. A filter may be placed in a location opposite a display element electrode 322. In one alternative, the transparent common electrode 320 may be disposed between the filters 336, 338, 340, or 342 and the microcapsules 326 associated with the particular sub-pixel.

The filters 336, 338, 340, or 342 may be provided in a variety of color combinations, e.g., the primary colors of red, green, and blue. In one embodiment, the filter 336 may be a blue color filter, the filter 338 may be a green color filter, the filter 340 may be a white filter, and the filter 342 may be a red color filter. The color filters may be provided in a variety of mosaic patterns, e.g., a Bayer pattern. When a color filter array (“CFA”) is placed over an array of electro-optic display elements, the individual elements may be referred to, in this description, as “subpixels” and the group of different colored subpixels that makes up a basic unit in the pattern may be referred to as a “super-pixel.” For example, the basic unit of color filter pattern may be a 2×2 array of subpixels that includes one red, one blue, and two green subpixels. As a second example, the basic unit of color filter pattern may be a 2×2 array of subpixels that includes one red, one blue, one green, and one white subpixel. In each of these examples, the super-pixel corresponds with the four subpixels. The sub-pixels are generally so small that the human visual system perceives the mixture of subpixels as a single color. The colors of the filters may be chosen so that they are either added together to produce the desired color, e.g., RGB, RGBW, or subtracted from white light to produce the desired color, e.g. CMY or CMYK. Any desired set of color filters may be used, e.g., RGB, CMY, RGBY, CMYB, or CMYK. The white filter 340 may be a transparent structure; alternatively, a white filter may be omitted or absent from the location between the microcapsules 326 associated with a particular sub-pixel and the common electrode 320. It is not critical that a super-pixel include precisely four subpixels; in alternative embodiments, a super-pixel may include any desired number of subpixels. In addition, it is not essential that a particular color be represented only once in a super-pixel; a super-pixel may include two or more sub-pixels of the same color. As examples, a super-pixel may include two or more green sub-pixels, or two or more white sub-pixels.

It is desirable that display devices reproduce color as accurately as possible. A monochrome electro-optic display element 134 may render different gray levels by reflecting varying amounts of light. As described above, particular gray levels may be produced by applying the appropriate waveform from a drive scheme to the display element 134. Similarly, a colored subpixel 334 may render the color at different levels of lightness by reflecting varying amounts of light. However, some problems may be encountered producing colors when using waveforms suitable for driving gray levels of monochrome display elements 134.

One problem is that a waveform suitable for rendering a particular gray level of a monochrome display element 134 may be inaccurate when employed to modulate the lightness of a colored subpixel 334. First, a colored subpixel may include a color filter. When a color filter is placed in front of an electro-optic display element, incident light must travel through the filter twice—first on the way to the element and a second time on the way to the viewer's eye. As a result of the two passes through the color filter, the quantity of light reflected by a color electro-optic display element 334 is reduced in comparison to a gray-scale electro-optic display element 134. A waveform suitable for rendering a particular gray level of a monochrome display element 134 may not account for this lower level of reflectivity of color subpixels 334. Second, the optical properties of filters used for different colored subpixels 334 may be different, e.g., differing in optical transmission or reflectance, e.g., a red filter may have different properties than a green filter. A waveform suitable for rendering a particular gray level may not account for the different optical properties of filters of different colors.

Another problem relates to the reflective nature of electro-optic display elements. Under some ambient lighting conditions, an electro-optic display element may reflect less light than may be desirable. Rendering an RGB value using an electro-optic display element under less-than-ideal lighting conditions may result in a color appearance that the lacks the lightness, hue, or saturation specified by the RGB value.

It is possible to compensate for the reduced reflectivity of color electro-optic display elements 334 as compared to gray-scale electro-optic display elements 134 by modifying input data values, e.g., input RGB data values, before using the input data values to select a suitable waveform. It is also possible to compensate for a lack of color accuracy that may occur under less-than-ideal lighting conditions by modifying input data values before using the data values to select a suitable waveform. An input data value may be modified using a color processing algorithm so that a waveform is selected that alters the perceived lightness, hue, or saturation of a color electro-optic display element. A unique color processing algorithm or a color processing algorithm with unique parameters may need to be transform input data values intended for display elements with different colored filters. For example, the color processing algorithm used to transform R color data values may differ from the color processing algorithm used to transform B color data values.

Modifying input data values before using the data to select a waveform for driving a transition to a new display state may include transforming the data so that equal steps in input are proportional to equal amounts of change in display state, a process sometimes referred to as “linearizing” or “gamma correcting.” In addition, input data may be transformed from the linearized input values to values that are optimized for a particular electro-optic display device. Transforming input data may include accounting for the specific CFA used in the particular electro-optic display device. In addition, the transformation of input data may include changing the color space of the input data. As one example, a white sub-pixel may be generated and added to each RGB input pixel to create RGBW pixels. Waveforms selected with the optimized values may cause the lightness, saturation, or hue of an electro-optic display element to change from how the element would otherwise have appeared. For example, the apparent brightness or saturation of a display element color may increase as the result of the optimizing transform. Waveforms selected with the optimized values may cause a color electro-optic display device to render color more accurately.

An apparatus may be provided for selecting waveforms for driving transitions to new display states. The apparatus may receive as input RGB values and select appropriate waveforms from a drive scheme suitable for producing gray levels in a monochrome electro-optic display element. The RGB values may be processed pixel-by-pixel. However, the apparatus performs one or more color processing algorithms on the input data prior to selecting waveforms. After receiving an RGB input value, the apparatus may linearize the input value. Next, the apparatus may optimize the linearized input value by performing one or more transforms on the linearized value. For example, the apparatus may modify the luminance of the RGB input data value. Luminance may be modified by transforming the RGB value into the YCrCb color space, scaling the Y component, and then transforming the YCrCb value back into the RGB color space. As another example, the apparatus may shift input color values so as to alter the specification of hue, saturation, or both descriptors. The apparatus may transform input values to another color space, e.g., YCrCb, and then shift the color in the new color space, or may shift color in the input color space, e.g., RGB. The color values of input data may be shifted by multiplying an RGB input vector by a 3×3 kernel matrix. In particular, the apparatus may shift color values using hardware or software that implements the following expression:

$$[ \begin{matrix}{R}^{′} \\ {G}^{′} \\ {B}^{′}\end{matrix} ] = [ \begin{matrix}{K}_{11} & {K}_{12} & {K}_{13} \\ {K}_{21} & {K}_{22} & {K}_{23} \\ {K}_{31} & {K}_{32} & {K}_{33}\end{matrix} ] \times [ \begin{matrix}{R}_{0} + {R}_{inoff} \\ {G}_{0} + {G}_{inoff} \\ {B}_{0} + {B}_{inoff}\end{matrix} ] + [ \begin{matrix}{R}_{outoff} \\ {G}_{outoff} \\ {B}_{outoff}\end{matrix} ]$$

where R₀, G₀, and B₀ are input RGB values. The R′, G′, and B′ are color corrected values. The respective RGB “inoff” and “outoff” are offset values. The “K” values of the 3×3 kernel matrix define the color shift. Additionally, the apparatus may perform a color processing algorithm in which input data may be used to generate an additional subpixel value for each super-pixel, e.g., a fourth sub-pixel may be generated and added to the input sub-pixels. The fourth sub-pixel may be any suitable color or may be no color. For instance, a fourth sub-pixel may be yellow or black, e.g., RGBY, CMYB, or CMYK pixels may be generated.

The following patent applications are hereby expressly incorporated herein by reference in their entirety: (a) co-pending U.S. patent application, entitled PROCESSING COLOR SUB-PIXELS, application Ser. No. 12/907,178, filed Oct. 19, 2010, attorney docket no. VP303; (b) co-pending U.S. patent application, entitled ARRANGING AND PROCESSING COLOR SUB-PIXELS, application Ser. No. 12/907,189, filed Oct. 19, 2010, attorney docket no. VP304; and (c) co-pending U.S. patent application, entitled ENHANCING COLOR IMAGES, application Ser. No. 12/907,208, filed Oct. 19, 2010, attorney docket no. VP307. These co-pending applications describe, inter alia, methods and apparatus for transforming input values to values that are optimized for a particular electro-optic display device, wherein the optimized values may be used to select waveforms from a monochrome drive scheme suitable for producing gray levels.

The use of an apparatus that transforms input data values according to one or more color processing algorithms and then selects waveforms using the optimized values from a monochrome drive scheme suitable for producing gray levels may add latency to an image update process, increasing the time required to update an electro-optic display with new information. In addition, use of an apparatus that transforms input data values into optimized input values may increase power consumption.

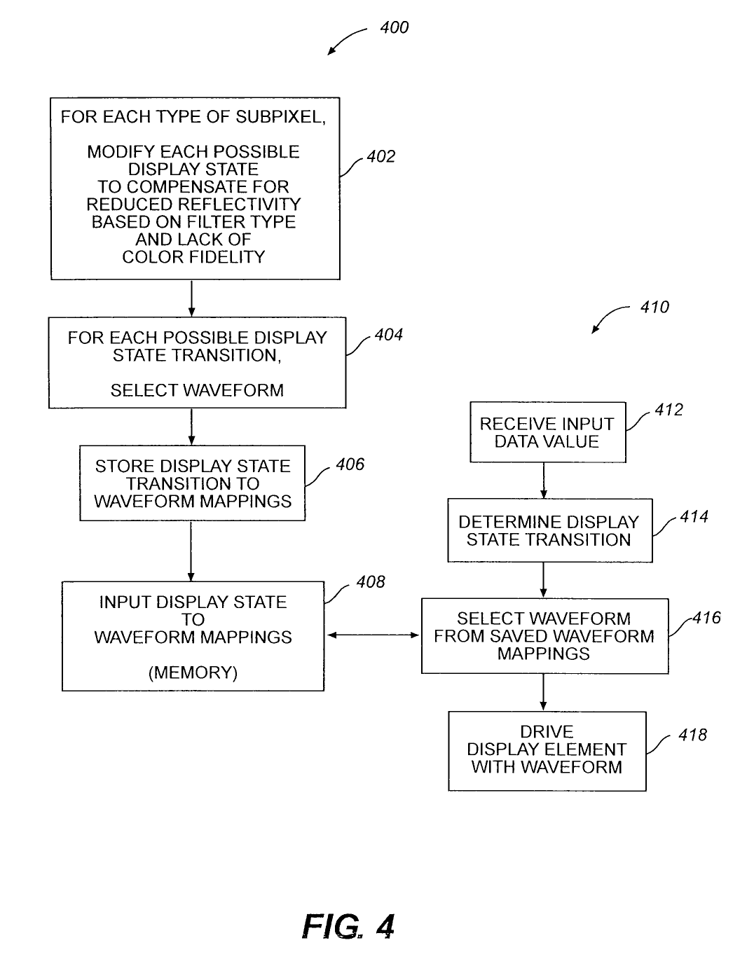

FIG. 4 illustrates methods 400 and 410 for driving a bi-stable, electro-optic color display according to one embodiment. The method 400 may be used to modify input data values in a way that compensates for a display element property, to select waveforms that compensate for a display element property, to map the selected waveforms to color input data values, and to record the mappings. The mappings of method 400 may be used in the method 410. In operation 402, the data values of each possible display state of a display element may be modified. The operation 402 may include modifying an input data value to compensate for the reduced reflectivity of a color electro-optic display element 334 as compared to gray-scale, electro-optic display element 134. In addition, the operation 402 may include modifying an input data value to compensate for a lack of color accuracy that may occur of a color electro-optic display element 334. The operation 402 may be performed for each color type of subpixel 334. For instance, an electro-optic display element 334 of a particular construction may be capable of accurately rendering 16 possible display states, in which each of the electro-optic display elements 334 may be provided with one of three different color filters, wherein the operation 402 may be performed for display elements with each type of color filter. Further, the operation 402 may include generating fourth sub-pixel values for each super-pixel, the fourth subpixel value being a function of the three input color values. Where a super-pixel includes one or more white subpixels, color processing algorithms different from those used where the super-pixel includes only the original three input color values may be used. In other words, the input values may be transformed differently if a white subpixel is added to each super-pixel. The operation 402 may be performed for added types of subpixel 334, e.g., added white subpixels.

In operation 404, for each possible display state transition, a corresponding waveform may be selected. For example, if an electro-optic display element 334 is capable of rendering 16 possible display states, then for each display state, there are 15 possible display state transitions to the display state. The display state transitions may be identified using the compensated input subpixel color values generated in operation 402. A waveform may be selected for each possible display state transition for each color type of subpixel, e.g., R, B, and G, or R, B, G, and W.

In operation 406, each possible input data value for a display element may be stored in a memory 408. In addition, the waveforms selected in operation 404 using the optimized input data values (determined in operation 402) may be stored in the memory 408. The memory may be organized in a way such that each input data value is mapped to the waveforms that were selected in operation 404 using the optimized version of the particular input data value. This memory organization permits an input data value to be used to identify the waveforms selected using an optimized version of the input data value. As mentioned, modifying an input data value in a way that compensates for a property of a particular display element intended for rendering the input subpixel data may produce an optimized version of the input data value.

The method 410 may be used as part of an image rendering process for a bi-stable, color electro-optic display device. In operation 412, an input data value is received. As one example, the input data value may be one subpixel value of an RGB pixel. In one embodiment, the method 401 may include an optional operation (not shown) of generating a fourth subpixel value from three input subpixel values. The fourth subpixel generation operation may be performed following the receipt of three input subpixel values. In operation 414, a display state transition is determined. The initial state of the transition may be the current state of the display element. The current state may be determined by retrieving the current display state from a memory. The next state of the transition may be the received input data value. In operation 416, the display state transition may be used to select a waveform from the memory 408. The selection of a drive waveform in operation 416 may take into account the CFA used by the particular display device. The selection of a drive waveform may include determining that a particular input data value corresponds with a particular color filter of the display. This determination may be made based on the sequential position of the input data value in the input data stream and the particular CFA. Alternatively, this determination may be made based on the spatial position of the subpixel (with which the input data value corresponds) in the particular CFA. In operation 418, the selected waveform may be used to drive a display element to the new display state. An advantage of the methods 400 and 410 is that input data values may be used to select, directly and with minimal latency, waveforms that compensate for a property of a display element. Additionally, the methods 400 and 410 may help reduce power consumption.

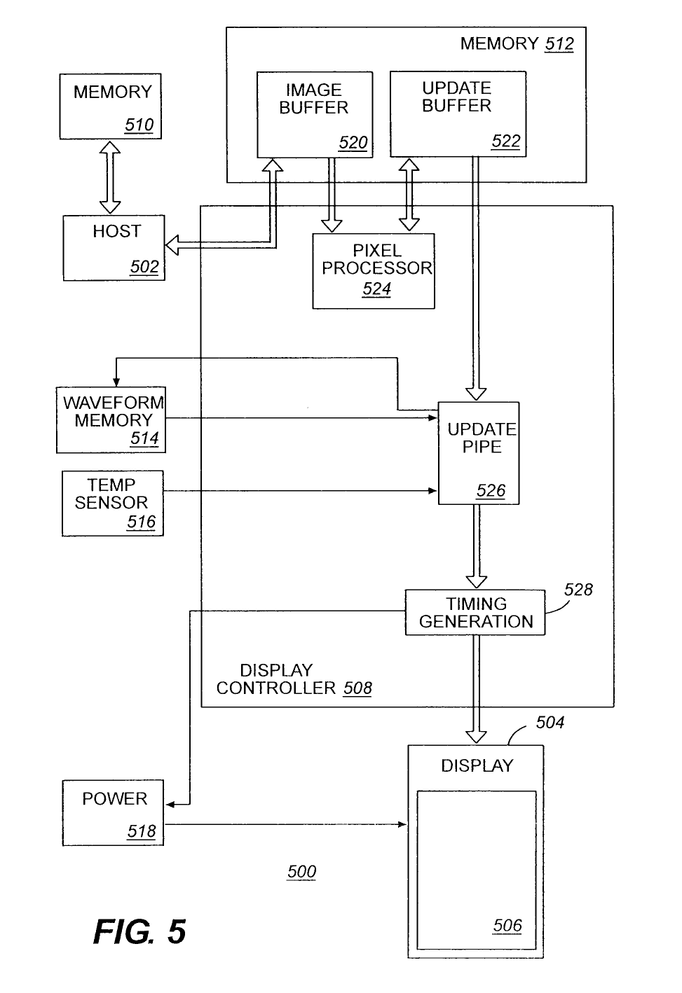

FIG. 5 shows a display system 500 according to one embodiment. The display system 500 may include a host 502, a bistable, color electro-optic display device 504 having a display panel 506, a display controller 508, and a system memory 510. The system 500 may also include a display memory 512, a waveform memory 514, a temperature sensor 516, and a display power module 518. The host 502 may be a CPU, DSP, or other device. The display memory 512 may be a volatile or non-volatile memory. In addition, the display memory 512 may be internal to the display controller 508, or it may be a separate component. The display memory 512 may include an image buffer 520 and an update buffer 522. The display controller 508 may include a pixel processor 524, one or more update pipes 526, and a timing generation unit 528.

The waveform memory 514 may store one or more drive schemes. A stored drive scheme may include data input values describing each possible display state of a display element. In addition, waveforms selected using optimized versions of all possible input data values may be stored in the waveform memory 514. A stored drive scheme may include each possible input data value for each color type of subpixel. In addition, a stored drive scheme may include waveforms selected using optimized input data values. An optimized input data value may be produced by modifying an input data value in a way that compensates for a property of a particular display element intended for rendering the input subpixel data. A stored drive scheme may be organized in a way such that each input data value is mapped to the waveforms that were selected using the optimized version of the particular input data value. This drive scheme organization permits an input data value to be used to identify the waveforms selected using an optimized version of the input data value. In one embodiment, a drive scheme may produced and stored in accord with the method 400 described above.

In operation, an image or a portion of an image may be stored in the image buffer 520 by the host 502. The image data may include input data values describing any color possible of being rendered by a display element. In addition, image data may include fourth subpixel data values generated from original input data. At a time when it is desired to update the display device 504, the image data for display elements to be updated may be read from the image buffer 520 by the pixel processor 524. In addition, the current display state of the display elements to be updated may be read from the update buffer 522 by the pixel processor 524. Display state transitions may be determined and written back to the update buffer 522 by the pixel processor 524. After one or more display state transitions are written back to the update buffer 522, the update pipe 526 may read the display state transitions for the display elements to be updated from the update buffer 522. In addition, the update pipe 526 may copy one or more drive schemes from the waveform memory 514. The drive schemes that are copied may be ones that are suitable for the particular CFA used in the display 504. In addition, the copied drive schemes may be ones that are suitable for environmental conditions, e.g., temperature, ambient lighting. The update pipe 526 may select a waveform for each display element to be updated from a drive scheme using the display state transitions. The update pipe 526 may select a drive waveform for a particular display state transition from a drive scheme that is optimized for use with a particular color filter of the display. This selection may be made based on the position of the subpixel associated with the display state transition in the particular CFA. In each frame period, the update pipe 526 may provide (or not provide), in accord with the selected waveform, a drive pulse for each display element to be updated. Drive pulses may be provided to the timing generation unit 528. During each frame period, the timing generation unit 528 may step through the display element locations of a frame in raster order. The timing generation unit 528 may provide waveform data to the display power module 518 and the display 504 in raster order and according to the timing requirements of the display device 504. The display power module 518 may convert data describing a pulse into a pulse that may be used to drive a display state transition. An advantage of the system 500 is that input data values may be used to select, directly and with minimal latency, waveforms that compensate for a property of a display element.

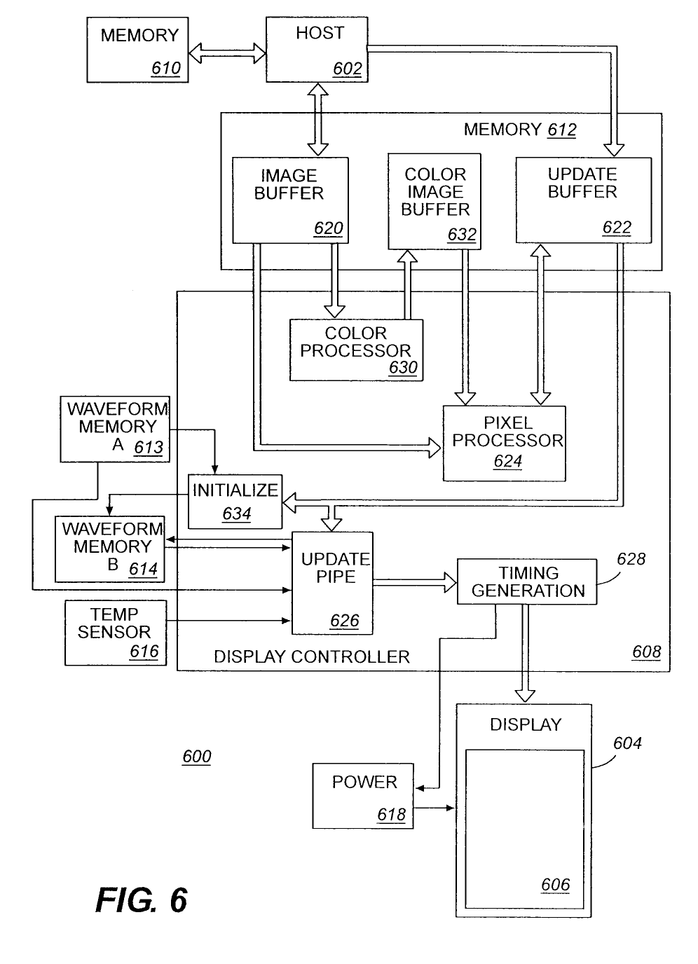

FIG. 6 shows a display system 600 according to one alternative embodiment. The display system 600 may include the same components as the system 500. The display system 600 may additionally include a waveform memory A (613) and the waveform memory 514 may be designated as waveform memory B (614). The display controller 608 may include the same elements as display controller 508, and additionally a color processor 630 and an initialization unit 634. The display memory 612 may include an image buffer 620, an update buffer 622, and may additionally include a color image buffer 632. The display controller 608 may operate in several different modes.

In a first mode of operation, the display controller 608 may operate similarly to the display controller 508 shown in FIG. 5. In the first mode, the color processor 630, initialization unit 634, color image buffer 632, and waveform memory A (613) are not used. In the first mode, the waveform memory B (614) is used to store the same data as described above for waveform memory 514. In particular, the waveform memory B (614) may store a drive scheme having data values describing each possible display state of a subpixel, and waveforms selected using optimized versions of input data values. The waveform memory B may map or associate the input data values describing each possible display state of a subpixel with the selected waveforms.

In a second mode of operation, the color processor 630, the waveform memory A (613), and the color image buffer 632 are used. The waveform memory B (614) and initialization unit 634 are not used. The waveform memory A (613) may store drive schemes having waveforms suitable for driving gray levels of a monochrome electro-optic pixel. In the second mode, image data may be fetched from the image buffer 620 by the color processor 630. The color processor 630 may perform one or more color processing algorithms on the image data. The color processing algorithm may adjust image data values to compensate for the reduced reflectivity of a color electro-optic display element as compared with a gray-scale electro-optic display element. In addition, a color processing algorithm may adjust image data values to make any desired type of compensation. The color processing algorithm may produce an optimized input data value by modifying an input data value in a way that compensates for a property of a particular display element intended for rendering particular input data. The optimized image data may be stored in the color image buffer 632 by the color processor 630. In the second mode, the pixel processor 624 may operate similarly to the pixel processor 524, except that it fetches optimized input image data from the color image buffer 632 instead of input data from the image buffer 620. The update pipe 626 may select a drive scheme suitable for particular environmental conditions from waveform memory A (613). The update pipe 626 may select a waveform for each display element to be updated from a drive scheme using the display state transitions. In each frame period, the update pipe 626 may provide (or not provide), in accord with the selected waveform, a drive pulse for each display element to be updated. Drive pulses may be provided to the timing generation unit 628. The timing generation unit 628 may operate in the manner described above for counterpart unit 528.

In a third mode of operation, the display controller 608 may be used to populate the waveform memory B (614) with waveforms selected using optimized versions of input data values. In addition, the waveform memory B (614) may be populated with data values describing each possible display state of a subpixel may be stored along with mappings to particular selected waveforms. In one embodiment, the display controller 608 in the third mode of operation may perform the method 400.

In the third mode of operation, the update pipe and the timing generation unit may not be used, however, this is not essential. Initialization image data may be stored in the image buffer 620 and the update buffer 622. The initialization image data stored in the image buffer 620 may include input data values of each possible display state of a color component of a display element. In addition, the initialization image data may include data values for each color type of subpixel. The initialization image data stored in the update buffer 622 may include data values for all possible display state transitions for a subpixel. In the third mode of operation, image data may be fetched from the image buffer 620 by the color processor 630. The color processor 630 may perform one or more color processing algorithms on the image data. The color processor 630 may generate fourth subpixel data values. The color processing algorithm may adjust image data values to compensate for the reduced reflectivity of a color electro-optic display element as compared with a gray-scale electro-optic display element. The color processing algorithm may produce an optimized input data value by modifying an input data value in a way that compensates for a property of a particular display element intended for rendering the input subpixel data. The optimized image data may be stored in the color image buffer 632 by the color processor 630. The optimized image data may be stored in the color image buffer 632 by the color processor 630. The pixel processor 624 may fetch image data from the color image buffer 632 and initialization image data describing all possible display state transitions. The pixel processor 624 may determine display state transitions and store the transitions in the update buffet 622. The initialization unit 634 may fetch the display state transitions and select waveforms from waveform memory A (613). The initialization unit 630 may then populate the waveform memory B (614) with the selected waveforms together with the display state of its associated input subpixel.

In one embodiment, some or all of the operations and methods described in this description may be performed by hardware, software, or by a combination of hardware and software.

In one embodiment, some or all of the operations and methods described in this description may be performed by executing instructions that are stored in or on a non-transitory computer-readable medium. The term “computer-readable medium” may include, but is not limited to, non-volatile memories, such as EPROMs, EEPROMs, ROMs, floppy disks, hard disks, flash memory, and optical media such as CD-ROMs and DVDs. The instructions may be executed by any suitable apparatus, e.g., the host 122 or the display controller 128. When the instructions are executed, the apparatus performs physical machine operations.

In this description, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

1. A method for driving a bi-stable color display, comprising:
receiving data describing a color display element of the display, the data including descriptions of two or more component colors;
determining a correspondence between one of the component colors and a particular subpixel of the color display element;
mapping the component color to a waveform, wherein the mapping accounts for a property of the particular subpixel; and
driving the subpixel with the mapped waveform.

2. The method of claim 1, wherein the particular subpixel includes a color filter and the property includes a property of the color filter.

3. The method of claim 2, wherein the color filter includes one of a red, green, or blue color filter.

4. The method of claim 3, wherein the color filter includes one of a red, green, blue, or white color filter.

5. The method of claim 1, wherein the property includes a relationship between the optical states of the particular subpixel and component color values.

6. The method of claim 1, further comprising generating an optimized data value by modifying an initialization data value to compensate for a display element property;
selecting a waveform using the optimized data value;
mapping the selected waveform to an input data value; and
recording the mappings in a memory.

7. The method of claim 6, wherein the mapping of the component color to a waveform includes fetching the mapping from the memory.

8. An image processing device for driving a bi-stable color display, comprising:
a first unit to receive data describing color pixels of the display, the data including, for each color pixel, descriptions of two or more component colors;
a second unit to determine correspondences between the component colors and particular subpixels of particular color pixels;
a third unit to map component colors to waveforms, wherein the mappings account for a property of the particular subpixel corresponding with the component color; and
a fourth unit to drive the subpixels with the mapped waveforms.

9. The device of claim 8, wherein the particular subpixel includes a color filter and the property includes a property of the color filter.

10. The device of claim 9, wherein the color filter includes one of a red, green, or blue color filter.

11. The device of claim 9, wherein the color filter includes one of a red, green, blue, or white color filter.

12. The device of claim 8, wherein the property includes a relationship between the optical states of the particular subpixel and component color values.

13. The device of claim 8, wherein the determination of correspondences between the component colors and particular subpixels of particular color pixels by the second unit takes into account the spatial position of the subpixel in a color filter array.

14. An image display system, comprising:
a bi-stable color display;
a first unit to receive data describing color pixels of the display, the data including, for each color pixel, descriptions of two or more component colors;
a second unit to determine correspondences between the component colors and particular subpixels of particular color pixels;
a third unit to map component colors to waveforms, wherein the mappings account for a property of the particular subpixel corresponding with the component color; and
a fourth unit to drive the subpixels with the mapped waveforms.

15. The system of claim 14, wherein the particular subpixel includes a color filter and the property includes a property of the color filter.

16. The system of claim 14, wherein the color filter includes one of a red, green, or blue color filter.

17. The system of claim 14, wherein the color filter includes one of a red, green, blue, or white color filter.

18. The system of claim 14, wherein the property includes a relationship between the optical states of the particular subpixel and component color values.

19. The system of claim 14, wherein the determination of correspondences between the component colors and particular subpixels of particular color pixels by the second unit takes into account the spatial position of the subpixel in a color filter array.
